(19) United States
(12) Patent Application Publication
(10) Pub. No.: US 2008/0159543 A1
(43) Pub. Date: Jul. 3, 2008

(54) Public Key Cryptographic Method And System, Certification Server And Memories Adapted For Said System

(75) Inventors: Laurent Frisch, Paris (FR); Gilles Macario-Rat, Vanves (FR)

Correspondence Address: YOUNG & THOMPSON, 209 Madison Street, Suite 500, ALEXANDRIA, VA, 22314, US

(73) Assignee: FRANCE TELECOM, Paris (FR)

(21) Appl. No.: 11/663,991

(22) PCT Filed: Sep. 28, 2005
(86) PCT No.: PCT/FR2005/002396

§ 371 Date: Jun. 13, 2007

(30) Foreign Application Priority Data
Sep. 29, 2004 (FR) 04 10307

(51) Int. Cl. H04L 9/06

(52) U.S. Cl. 380/282

(57) ABSTRACT

The invention relates to a public key cryptographic method and system, a certification server and memories adapted for said system. In said public key cryptographic system, there is insufficient information contained in an electronic public key certificate alone to retrieve the public key. The inventive system comprises at least a second memory (52, 72) in which complementary information is stored, which can be used to retrieve the public key when used together with the information contained in the certificate. According to the invention, access to said complementary information is reserved to a limited number of authorised terminals among the group of terminals that can verify the certificate signature.

The present invention relates to a public key cryptographic method and system and a certification server, and memories adapted for said system.

Public key cryptographic systems comprise:

a computing entity suitable for decrypting a message and/or signing with the aid of a private key corresponding to the public key,

at least one first memory in which an electronic certificate of the public key signed by a certification authority is recorded, said certificate comprising information for retrieving the public key, and

at least one terminal capable of verifying the signature of the certificate and of retrieving the public key from the information contained in the certificate before encrypting a message and/or verifying a signature with the aid of this public key.

In known public key cryptographic systems, the electronic certificate comprises a field in which the public key is recorded in plain text. This electronic certificate is public and is therefore transmitted to any terminal which requests it. This certificate is used by the terminals to verify that the public key that it wishes to use is indeed the one that corresponds to the private key used by the computing entity. However, situations exist in which it is desirable that, among all of the terminals capable of verifying the signature of the electronic certificate, only some of them, referred to hereinbelow as authorized terminals, can retrieve the public key. Cryptographic systems in which public key electronic certificates are used do not currently enable restriction of access to the public key contained in the certificate.

The invention is intended to overcome this disadvantage by proposing a public key cryptographic system in which access to the public key is restricted to authorized terminals.

The object of the invention is therefore a public key cryptographic system in which the information contained in the certificate is insufficient in itself to retrieve the public key to be used. The system comprises at least one second memory in which the complementary information enabling retrieval of the public key is recorded when it is used in combination with the information contained in the certificate, access to this complementary information being restricted to a limited number of authorized terminals among all of the terminals capable of verifying the signature of the certificate.

In the above system, only authorized terminals have access to the complementary information and can therefore retrieve the public key. The complementary information is restricted to a limited number of authorized terminals among all of the terminals capable of verifying the signature of the electronic certificate. Thus, the public key can only be retrieved by these authorized terminals, thereby restricting the accessibility of this public key while using a public key electronic certificate.

The embodiments of this system may comprise one or more of the following characteristics:

the information contained in the certificate comprises a cryptogram of at least part of the public key, and the complementary information comprises a decryption key enabling decryption of the cryptogram,

the information contained in the certificate comprises an identifier of at least part of the public key in a list, said list comprising a plurality of said at least one key part, each associated with an identifier, and the complementary information comprises this list,

the information contained in the certificate comprises the address of an authentication server suitable for authorizing access to at least part of the complementary information in response to the correct identification and/or authentication of a terminal,

the information contained in the certificate comprises an identifier of a method for retrieving the complementary information from among a plurality of possible retrieval methods, and the system comprises at least one list of retrieval methods enabling identification of the retrieval method to be used according to the identifier of the retrieval method.

The object of the invention is also a certification server of a certification authority, a memory comprising this electronic certificate and a memory comprising the complementary information used in the above system.

The object of the invention is also a public key cryptographic method implemented in the system described above.

The invention will be more readily understood by reading the description which follows, provided purely as an example and produced with reference to the drawings, in which:

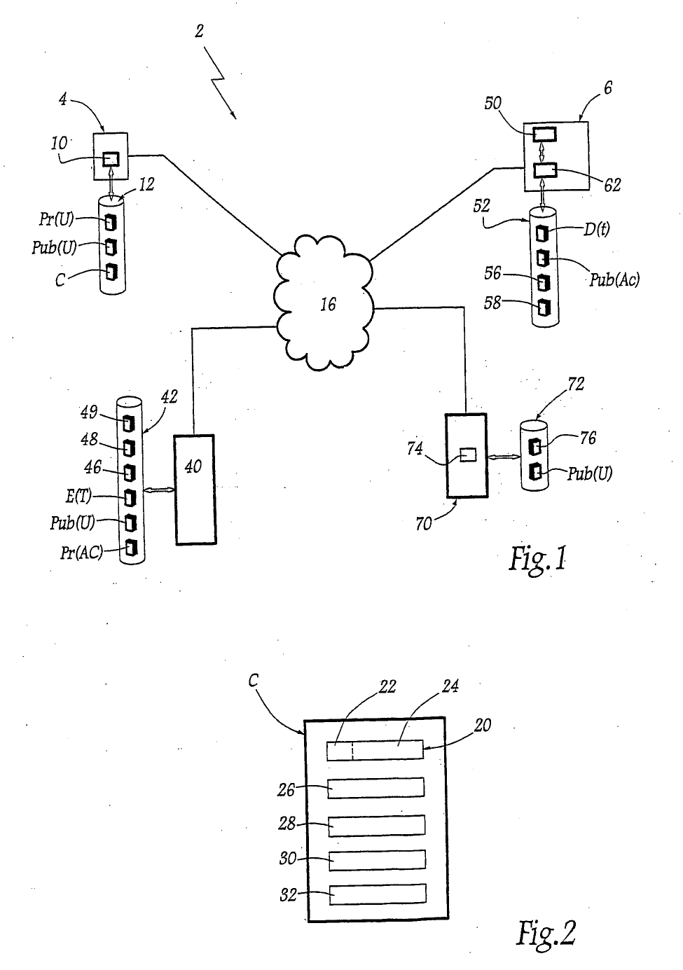

FIG. 1 is a schematic illustration of the architecture of a public key cryptographic system,

FIG. 2 is a schematic illustration of a public key electronic certificate used in the system shown in FIG. 1, and

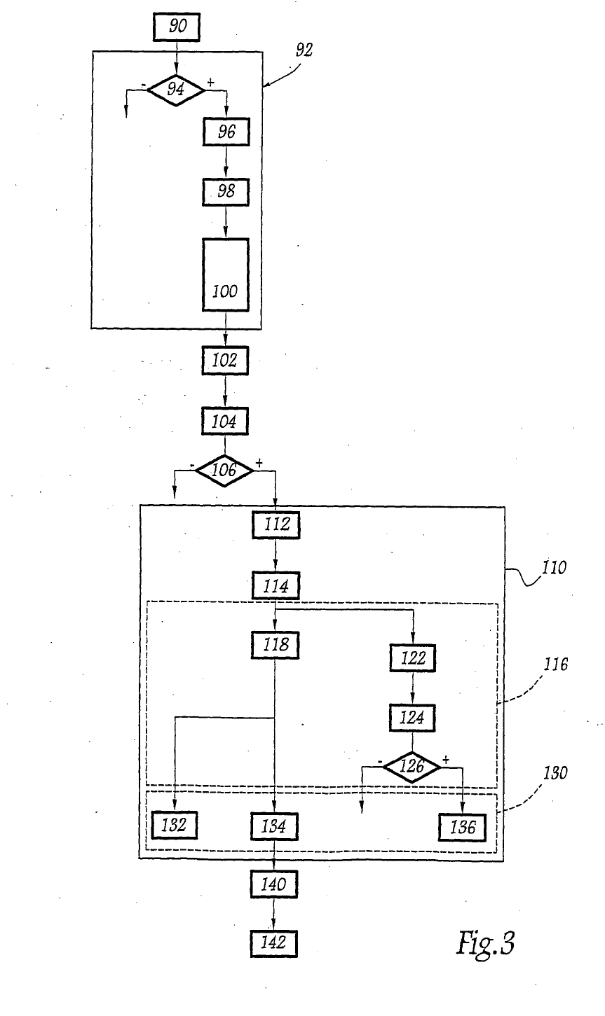

FIG. 3 is a flow chart of a public key cryptographic method.

FIG. 1 represents a public key cryptographic system designated by the general reference 2. This system 2 comprises a computing entity 4 suitable for decrypting a message and/or signing with the aid of a private key Pr(U) and terminals suitable for encrypting a message and/or verifying a signature with the aid of a public key Pub(U) corresponding to the private key Pr(U). To simplify the illustration, only one terminal 6 is shown.

The entity 4 comprises, in particular, an electronic decryption module 10 for decrypting a message and/or signing with the aid of the key Pr(U). To do this, the module 10 is connected to a memory 12 containing the key Pr(U).

Here, this memory 12 also comprises the public key Pub(U) and an electronic certificate C of the public key Pub(U). This certificate C is adapted so that the terminals such as the terminal 6 can verify that the public key Pub(U) that it wishes to use actually corresponds to the private key Pr(U) used by the entity 4.

The entity 4 is connected to the different terminals with which it is capable of exchanging encrypted messages via an information transmission network 16. This network 16 is a local network or a long-distance network such as the Internet network.

The entity 4 is, for example, a computer server.

The certificate C of the entity 4 is shown in more detail in FIG. 2. This certificate C comprises a location 20 comprising two information fields 22 and 24. The field 22 is normally intended to contain an identifier of an encryption or decryption algorithm, and the field 24 is normally intended to contain the public key in plain text to be used in conjunction with the algorithm identified by the field 22. The exact content of the field 22 and the content Pub′(U) of the field 24, in the context of the system 2, will be described in more detail below. The certificate C also comprises other fields such as, in particular:

a field 26 intended to contain the identity of the owner of the certificate C, i.e., here, the identity of the entity 4 such as, for example, its name or its address on the network 16,

a field 22 intended to contain a validity period for the certificate C,

a field 30 containing the serial number of the certificate, said serial number being allocated by the certification authority and being unique.

Finally, the certificate C contains a cryptographic signature 32 produced by encrypting, for example, all or only some of the information contained in the preceding fields with the aid of a private key Pr(AC) of the certification authority. This signature enables a terminal to verify the authenticity of the certificate and therefore to have confidence in the information contained in this certificate and, in particular, the information contained in the location 20.

Here, the structure of this certificate complies with the X.509 standard of the IETF (Internet Engineering Task Force) RFC3280, used on the Internet network.

The system 2 also comprises at least one certification server 40 of the certification authority having produced the certificate C. To do this, the server 40 is associated with a memory 42 in which the key Pr(AC) which served to sign the certificate C is recorded.

Here, by way of example, this memory 42 also comprises the public key Pub(U), a cryptographic key E(T) and a list 46 of a plurality of keys associating a unique identifier with each public key. This list 46 comprises, in particular, an identifier for the key Pub(U). The key E(T) is, for example, a public key corresponding to a known private key D(T) which is used only by the terminal 6.

The memory 42 also comprises a list 48 of methods for establishing the content Pub′(U) of the field 24 and a list 49 of methods for retrieving the key Pub(U). For each establishment method, the list 48 comprises an identifier Pᵢ of the method. In the list 49, the same identifier Pᵢ is associated with the retrieval method enabling retrieval of the key Pub(U) from the content Pub′(U) established according to the establishment method Pᵢ.

The server 40 is connected to the network 16 to transmit, via this network, the certificates that it has produced.

The terminal 6 comprises a signature encryption and/or verification module 50 capable of running the cryptographic algorithms. To do this, this module 50 is associated with a memory 52 comprising the cryptographic algorithms used and also the corresponding keys. For example, here, the memory 52 comprises, in particular, a public key Pub(AC). This memory 52 also comprises complementary information enabling retrieval of the key Pub(U) when said information is used in conjunction with the information contained in the certificate C. Here, the memory 52 comprises the key D(T), a list 56 of keys associating a public key for each key identifier, and a list 58 of methods for retrieving the key Pub(U). The list 56 is, for example, identical to the list 46. The list 58 associates each retrieval method with an identifier of this method. This list 58 is, for example, identical to the list 49.

Access to the memory 52 is restricted to a limited number of authorized terminals such as, for example, the terminal 6, among all of the terminals capable of verifying the signature of the certificate C. To do this, the system 2 comprises a module 62 for restricting access to the complementary information contained in the memory 52. This module 62 is, for example, capable of identifying and/or authenticating a third party before authorizing access to the memory 52. Here, by way of illustration, this module 62 is implemented in the terminal 6 in particular to identify and authenticate the user of the terminal 6 before the module 50 can access the memory 52.

Finally, the system 2 comprises an identification and authentication server 70 connected to the network 16. This server 70 is associated with a memory 72 containing the public key Pub(U). In order to restrict access to this key Pub(U) to authorized terminals only, the server 70 comprises a restriction module 74 capable of identifying and authenticating a terminal or a user before authorizing access to the key Pub(U) contained in its memory 72. To do this, the memory 72 comprises, for example, a list 76 of identifiers and authenticators of the authorized terminals to which the key Pub(U) can be disclosed. The authenticator is, for example, a simple password.

The operation of the system 2 will now be described in relation to the method shown in FIG. 3.

Initially, during a step 90, the entity 4 transmits a request to the certification server 40 in order to obtain the certificate C for the public key Pub(U). This request contains, for example, proof that the entity 4 possesses the private key Pr (U). To do this, for example, the entity 4 signs a message with its private key Pr(U). This request contains other information enabling the entity 4 to be identified, such as its name or its address on the network 16.

In response to this request, during a phase 92, the certification server 40 produces the certificate C. More precisely, the server 40 starts by verifying, during a step 94, the proof transmitted by the entity 4. For example, the server 40, with the aid of the key Pub(U), decrypts the message encrypted with the aid of the key Pr(U) transmitted during the step 90. In the event that this verification is negative, the method stops. In the opposite event, the server, during a step 96, chooses a method for establishing the information contained in the certificate C and, more precisely, the information contained in the element 20 of the certificate. This establishment method is chosen, for example, from the list 48.

By way of illustration, the list 48 comprises three methods P₁, P₂ and P₃ for establishing the content Pub′(U) of the field 24.

According to the method P₁, the content Pub′(U) is obtained by encrypting the key Pub(U) with the aid of the key E(T).

According to the method P₂, the content Pub′(U) is the identifier associated with the public key Pub(U) in the list 46.

Finally, according to the method P₃, the content Pub′(U) is the address on the network 16 of the authentication server 70.

Regardless of the establishment method chosen, the other fields of the certificate are completed as advocated by the X.509 standard.

Once the method for establishing Pub′(U) has been chosen, this method is carried out during a step 98.

At the end of the step 98, the certificate of the key Pub(U) is produced, during a step 100, by completing the field 22 with the identifier Pᵢ of the method for retrieving the key Pub(U) and the field 24 with the content Pub′(U). Here, the identifier Pᵢ of the retrieval method is identical to the identifier Pᵢ of the method for establishing the content Pub′(U).

Once the phase 92 for producing the certificate has ended, the server 40, in a step 102, transmits this certificate C to the entity 4 which stores it in its memory 12.

During an exchange of encrypted information between the terminal 6 and the entity 4, the entity 4, in a step 104, transmits the certificate C to the terminal 6. The terminal 6 records it in a non-volatile memory, such as the memory 52, or in a volatile memory, and, during a step 106, verifies the signature of this certificate C. To do this, during the step 106, the terminal 6 decrypts the signature 32 with the aid of the key Pub(AC). If this verification is negative, i.e. the certificate C is not authenticated, the method then stops. In the opposite event, the terminal 6 moves on to a phase 110 in which the public key Pub(U) is retrieved.

At the start of the phase 110, during a step 112, the terminal 6 identifies the method for retrieving the key Pub(U) to be used by using the content of the field 22 of the certificate C.

Then, during a step 114, the terminal 6 extracts the content Pub′(U) from the field 24.

Then, during a step 116, the terminal 6 accesses the complementary information required in order to obtain the key Pub(U) from the content Pub′(U).

In the event that the identifier of the retrieval method is P₁ or P₂, the module 62, during an operation 128, verifies that the conditions for accessing the memory 52 are satisfied. For example, access to the memory 52 is authorized only if the user of the terminal 6 is correctly identified and authenticated.

In the event that the identifier of the retrieval method is P₃, the terminal 6, during an operation 122, connects to the authentication server identified by the address contained in the field 24. Here, it is assumed that this address is the address of the identification and authentication server 70. Then, during an operation 124, the terminal 6 transmits the information enabling its identification and authentication to the server 70. During a step 126, the module 74 verifies whether the identification and authentication information transmitted by the terminal 6 corresponds to identification and authentication information contained in the list 76. If so, the module 74 authorizes access to the complementary information comprising here the key Pub(U) recorded in the memory 72. If not, the method stops.

Once the terminal 6 has been authorized to access the complementary information, during a step 130, said terminal uses the complementary information in order to retrieve the key Pub(U). More precisely, during this step 130, if the identifier of the retrieval method is P₁, the terminal 6, during an operation 132, decrypts the content Pub′(U) with the aid of the key D(T).

If the identifier of the retrieval method is P₂, the content Pub′(U) corresponds to an identifier of the key Pub(U) in the list 56. Then, during an operation 134, the terminal 6 retrieves the key Pub(U) from the list 56 using this identifier.

If the identifier of the retrieval method is P₃, the terminal 6, during an operation 136, retrieves the key Pub(U) recorded in the memory 72 of the server 70.

Once the key Pub(U) has been retrieved, the terminal 6 uses it to encrypt a message and/or verify the signature of the entity 4. For example, during a step 140, the terminal encrypts a message transmitted to the entity 4 with the aid of the key Pub(U), then, during a step 142, the entity 4 decrypts this message with the aid of the key Pr(U).

As a variant, during the step 140, the entity 4 transmits to the terminal 6 a signature produced with the aid of the key Pr(U) and the terminal 6 verifies this signature, during the step 142, with the aid of the key Pub(U).

The key Pub(U) retrieved in this way may also be used to authenticate the entity 4 during exchanges of information between the terminal 6 and the entity 4. For example, the terminal 6 transmits a random number to the entity 4, which encrypts or signs it with the aid of the key Pr(U) and forwards the cryptogram thus produced to the terminal 6. The terminal 6 decrypts the transmitted cryptogram with the aid of the public key Pub(U) in order to authenticate the entity 4.

Other uses of the public key are possible.

In the above system 2, although the certificate C is public, i.e. it can be obtained by numerous terminals and numerous terminals of the system 2 are capable of verifying the signature of this certificate, only authorized terminals can retrieve the public key from the information contained in this certificate. For unauthorized terminals, i.e. those which do not have access to the complementary information, the certificate C cannot be used to retrieve the key Pub(U). Thus, in the system 2, access to the public key Pub(U) is restricted, even though a public key certificate is used.

In the system described above, the structure of the electronic certificate is not modified, so that it is possible to comply with the current standards for electronic certificates. It is therefore possible to implement the method described above using standard protocols for the use of electronic certificates such as, for example, the SSL/TLS protocol of the IETF RFC2246, S/MIME of the IETF RFC3851, or PKCS, which is one of the private standards from RSA Security (see http://www.rsasecurity.com/rsalabs/node.asp?id=2124). This limits the cost of implementing the system 2.

Numerous other embodiments of the system 2 are possible. For example, the keys E(T) and D(T) can be replaced by symmetric keys.

The software restriction module 62 can be replaced by a mechanical restriction module to restrict access to the memory 52. For example, the memory 52 may only be accessible from the terminal 6. This will be the case, for example, if the terminal 6 is a computer and if the memory 52 corresponds to a non-shared portion of the hard disk of this computer.

In the system 2, the certificate is recorded in a memory 12 associated with the entity 4, then transmitted via the network 16 to the terminal 6. As a variant, the certificate C is recorded in a portable memory such as, for example, the memory of a chip card, and it is this portable memory which is transmitted to the terminal 6 when said terminal wishes to communicate with the entity 4. The certificate C may also be recorded in a directory which can be consulted by all the terminals in such a way that, in this variant, the step 104 of the method is replaced by a step of consulting this directory.

Here, the list 58 of the retrieval methods has been described as constituting part of the complementary information to which access is restricted to authorized terminals. As a variant, this list 58 is recorded in a memory which can be freely accessed by all the authorized or unauthorized terminals of the system 2.

In the case of the retrieval method P₁, the content Pub′(U) can be formed by the concatenation of a plurality of cryptograms of the key Pub(U) obtained with the aid of the keys E(T₁), E(T₂), . . . , respectively, the keys E (Tᵢ) being respective cryptographic keys of the authorized terminals T₁, T₂, . . .

Still in the case of the retrieval method P₁, the content Pub′(U) can be formed by a cryptogram A of the key Pub(U) obtained with the aid of a key K and cryptograms Kᵢ obtained by encrypting the key K with the aid of keys E (Tᵢ) associated with each of the authorized terminals Tᵢ. In this variant, the content Pub′(U) will preferably comply with the PKCS#7/CMS standard.

In the case of the retrieval method P₂, the identifier of the key Pub(U) has been described as being predefined in a list 46. As a variant, this identifier is dynamically created by the authentication server during the creation of the certificate C and the authentication server is capable of updating the list 56 of the terminal 6 so that said terminal comprises the dynamically created identifier associated with public key Pub(U).

Still in the case of the retrieval method P₂, rather than creating an identifier, the authentication server, as a variant, uses as the identifier of the key Pub(U) one or more of the information elements contained in the other fields of the certificate, such as, for example, the serial number of the certificate. In this variant, the field 22 contains the identifier P₂ and the field 24 is empty since, for example, the serial number of the certificate is already contained in the field 30.

In the case of the retrieval method P₃, the server 70 has been described as being separate from the server 40. As a variant, these two servers are combined. As a variant, the server 70 is either only capable of identifying a terminal or only capable of authenticating a terminal.

The system 2 has been described in the specific case where three methods for retrieving the key Pub(U) can be used. As a variant, only one or two of these retrieval methods are used. The elements corresponding to the retrieval methods which are not used are then removed from the system 2. In particular, in the case where a single retrieval method is used in the system 2, the step 96 can be removed and the retrieval phase 110 can be simplified.

Finally, the system 2 has been described in the specific case where all of the complementary information required in order to retrieve the key Pub(U) by implementing a retrieval method Pᵢ is recorded in a single location. As a variant, the complementary information to be used when carrying out a retrieval method Pᵢ is distributed among different memories protected by different access restriction modules.

The retrieval methods P_{I} described here can also be combined. For example, the key Pub(U) is split into a first and a second part. The first part is encrypted with the aid of the key E(T) and the second part is recorded in the memory 72 of the authentication server 70. The content Pub′(U) is then formed by the cryptogram of the first part of the key and by the address of the authentication server. The content Pub′(U) can also be formed by an identifier of the first part of the key Pub(U) in a list recorded in the memory 52, and by the address of an authentication server capable of authorizing access to the second part of the key Pub(U).

The memories described here can also be specific zones of larger information storage means.

1-10. (canceled)

11. A public key cryptographic system comprising:
a computing entity (4) suitable for decrypting a message and/or signing with the aid of a private key corresponding to the public key,
at least one first memory (12) in which an electronic certificate of the public key signed by a certification authority is recorded, said certificate comprising information for retrieving the public key, and
at least one terminal (6) capable of verifying the signature of the certificate and for retrieving the public key from the information contained in the certificate before encrypting a message and/or verifying a signature with the aid of this public key, wherein :
the information contained in the certificate is insufficient in itself to retrieve the public key to be used, and comprises at least one identifier and/or at least one address for retrieving the public key to be used, and
the system comprises at least one second memory (52, 72) in which the complementary information enabling retrieval of the public key is recorded when it is used in combination with the information contained in the certificate, access to this complementary information being restricted to a limited number of authorized terminals among all of the terminals capable of verifying the signature of the certificate.

12. The system as claimed in claim 11, wherein the information contained in the certificate comprises an identifier of at least part of the public key in a list, said list comprising a plurality of said at least one key part, each associated with an identifier, and the complementary information comprises this list.

13. The system as claimed in claim 11, wherein the information contained in the certificate comprises the address of an authentication server (70) suitable for authorizing access to at least part of the complementary information in response to the correct identification and/or authentication of a terminal.

14. The system as claimed in claim 11, wherein the information contained in the certificate comprises at least one identifier of a method for retrieving the complementary information from among a plurality of possible retrieval methods, and the system comprises at least one list of retrieval methods enabling identification of the retrieval method to be used according to the identifier of the retrieval method.

15. A certification server of a certification authority, wherein it is capable of generating an electronic certificate of a public key adapted for use in a system as claimed in claim 11, said electronic certificate comprising information for retrieving the public key, this information contained in this certificate is insufficient in itself to retrieve the public key, and this information comprises at least one identifier and/or at least one address for retrieving the public key to be used.

16. A memory comprising an electronic certificate adapted for use in a public key cryptographic system, wherein the electronic certificate comprises information for retrieving the public key, and this information is insufficient in itself to retrieve the public key, the information comprising at least one identifier and/or at least one address for retrieving the public key to be used.

17. A memory adapted for use in a cryptographic system, wherein it comprises complementary information enabling identification of a public key when said information is used in combination with information contained in an electronic certificate.

18. A public key cryptographic method adapted for implementation in a public key cryptographic system, wherein it comprises a step of using complementary information taken in combination with information contained in an electronic certificate in order to retrieve a public key, said information contained in the electronic certificate being insufficient in itself to retrieve the public key to be used, and said information comprising at least one identifier and/or at least one address for retrieving the public key to be used.

19. An electronic certificate adapted for use in a public key cryptographic system, wherein the electronic certificate comprises information for retrieving the public key, said information being insufficient in itself to retrieve the public key to be used, and said information comprising at least one identifier and/or at least one address for retrieving the public key to be used.

20. A certification server of a certification authority, wherein it is capable of generating an electronic certificate of a public key adapted for use in a system as claimed in claim 12, said electronic certificate comprising information for retrieving the public key, this information contained in this certificate is insufficient in itself to retrieve the public key, and this information comprises at least one identifier and/or at least one address for retrieving the public key to be used.

21. A certification server of a certification authority, wherein it is capable of generating an electronic certificate of a public key adapted for use in a system as claimed in claim 13, said electronic certificate comprising information for retrieving the public key, this information contained in this certificate is insufficient in itself to retrieve the public key, and this information comprises at least one identifier and/or at least one address for retrieving the public key to be used.

22. A certification server of a certification authority, wherein it is capable of generating an electronic certificate of a public key adapted for use in a system as claimed in claim 14, said electronic certificate comprising information for retrieving the public key, this information contained in this certificate is insufficient in itself to retrieve the public key, and this information comprises at least one identifier and/or at least one address for retrieving the public key to be used.
